(19) United States
(12) Patent Application Publication
(10) Pub. No.: US 2007/0250287 A1
(43) Pub. Date: Oct. 25, 2007

(54) Orthopods and equipment to generate orthopedic supports from computerized data inputs

(76) Inventor: Donald Spector, New York, NY (US)

Correspondence Address: Glen M. Diehl;DIEHL SERVILLA, LLC, Suite 110, 77 Brant Avenue, Clark, NJ, 07066, US

(21) Appl. No.: 11/408,769

(22) Filed: Apr. 21, 2006

(51) Int. Cl. G06F 19/00

(52) U.S. Cl. 702/139; 36/140; 702/1; 702/41; 702/127; 702/138; 702/140; 702/189; 700/90; 700/95; 700/97; 700/117

(57) ABSTRACT

Systems and methods for measuring feet and designing and creating orthopedic inserts are described. The method can include measuring a pressure the foot exerts during a stride at a plurality of points over a period of time, analyzing a pressure at the plurality of points over the period of time and designing the orthopedic insert based on the analysis. The system can include a device that measures a pressure exerted by a foot at a plurality of times at each of a plurality of points and a computer connected to the device, the computer having memory that stores the measured pressures and a program operable to analyze the measured pressures to create a design of an orthopedic insert.

### BACKGROUND OF THE INVENTION

This product relates to the field of orthopedic inserts for shoes, sneakers and other footwear.

These product lines are typically divided into two categories. One such category is defined by relatively universal insoles that cushion and provide general support. A previous patent discloses the first adjustable insole, in which the bounce of the insole can be controlled by turning a valve. Other products on the market are those such as manufactured under the brand name Dr. Scholl's.

Most of these products tend to be for comfort or support and are universal in use. They are relatively inexpensive.

At the other end of the spectrum are the devices referred to as supports. These are often made by Podiatrists. Podiatrists take imprints and casts of people's feet and then have inserts designed that are made to correct the weight and imprint of the foot.

Accordingly, new and improved methods and systems to provide orthopedic insets are needed.

### SUMMARY OF THE INVENTION

One aspect of the present invention is a method of measuring a foot and developing an orthopedic insert. The invention includes measuring a pressure the foot exerts during a stride at a plurality of points over a period of time, analyzing a pressure at the plurality of points over the period of time and designing the orthopedic insert based on the analysis. Another aspect of the present invention also includes milling the orthopedic insert based on the design.

The analysis step can include comparing the pressure at a first of the plurality of points at a first time to the pressure at the first of the plurality of points at a second time. It can also include comparing the pressure at a first of the plurality of points at a first time to the pressure at one or more or plurality of points that are neighbors to the first of the plurality of points.

Another aspect of the present invention provides a device for dynamically measuring pressure exerted by a foot during a stride. The device can include a sock adapted to be pulled over the foot, a plurality of sensors on a bottom surface of the sock, the plurality of sensors adapted to sense pressure exerted by the foot and a communications device on the sock and connected to the plurality of sensors.

The communications device can be a wireless transmitter. It can also include a memory that stores an output of the plurality of sensors. Alternatively, the communications device can include a wired output that can be connected to an external device to download information from the plurality of sensors.

Other devices for dynamically measuring pressure exerted by a foot are also contemplated by the present invention. In accordance with another aspect of the present invention, a device can include a platform long enough to cover at least one stride of the person, a first plurality of pressure sensors along a length of the platform, the first plurality of pressure sensors being wide enough to entirely receive the foot, so that each of the first plurality of pressure sensors can determine a pressure being exerted by the foot at one or more times and an output device connected to the first plurality of sensors.

This device can also include a memory that receives and stores a plurality of pressure measurements from each of the plurality of sensors. This device can also include a second plurality of pressure sensors along a length of the platform, the second plurality of pressure sensors being wide enough to entirely receive the foot, so that each of the second plurality of pressure sensors can determine a pressure being exerted by the foot at one or more times.

The sensors can be piezoelectric devices. They can also be pressure pins.

The platform can also be sized long enough to cover a plurality of strides of the person.

The device can also include imaging means for monitoring the foot during the stride.

Another aspect of the present invention provides a system for measuring a foot and designing and creating an orthopedic insert. The system, in accordance with one aspect of the present invention, includes a device that measures a pressure exerted by a foot at a plurality of times at each of a plurality of points and a computer connected to the device, the computer having memory that stores the measured pressures and a program operable to analyze the measured pressures to create a design of an orthopedic insert.

The system can also include a milling machine that can receive the design of the orthopedic insert and mill the orthopedic insert.

The system can analyze the data in accordance with the methods described herein.

### DESCRIPTION OF THE DRAWINGS

FIG. 1 illustrates a system in accordance with one aspect of the present invention.

FIGS. 2 and 4 illustrate a dynamic foot measurement device in accordance with a further aspect of the present invention.

FIG. 3 illustrates a control circuit.

FIG. 5 illustrates another dynamic foot measurement device in accordance with another aspect of the present invention.

FIG. 6 illustrates a response provided by one of the sensors of a dynamic foot measurement device.

FIG. 7 illustrates computer images of pressure gradients generated by a dynamic foot measurement device in accordance with one aspect of the present invention.

FIG. 8 illustrates a method in accordance with a further aspect of the present invention.

### DESCRIPTION OF A PREFERRED EMBODIMENT

One object of this invention to create a collateral informational base that is immediately capable of altering the manufacture of inserts on a personal basis in an economic way. This can be particularly important since the cost of inserts by podiatrists typically cost hundreds of dollars, for an end product that probably has a cost of goods of only a few dollars. The computerized instructions for the manufacturing of the insert can be transmitted to a foreign country where these inserts can be made by hand or eventually transmitted to machines that can actually create three dimensional moldings that can then be sold to the consumers at a faction of the cost of present inserts sold by Podiatrists. These inserts will also be more accurate since they measure not only static by dynamic motion. This invention involves both the manual and automatic means of manufacturing inserts based on dynamic models from computers.

This system of creating a new type of insole is seen as similar to the revolution that has taken place in optical systems where optometrists have found a way to inexpensively service a great many people with ever more sophisticated forms of glasses and contact lenses at ever decreasing costs.

It is further envisioned that new schools will be set up with a specific syllabi that will teach those that operate such equipment have the necessary information to help customers, but possibly as different degree of training than the traditional podiatrist.

The collateral development of a curriculum and a school for what we will trademark as OrthoPods is also made a part of this instant invention.

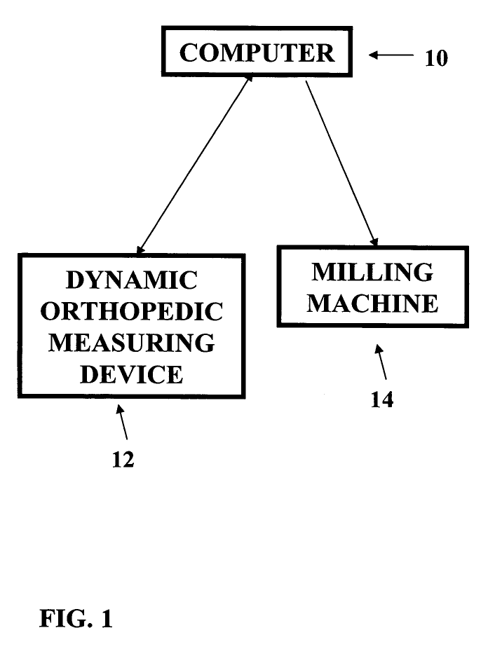

FIG. 1 illustrates a system in accordance with one aspect of the present invention. A computer/processor 10 is connected to a dynamic orthopedic measuring device 12. The dynamic orthopedic measuring device 12 measures the pressure from a foot or feet over time, provides the pressure data to the computer 10. The computer analyzes the data and designs an orthopedic insert. The orthopedic insert design is provided by the computer 10 to a milling machine 14. The milling machine 14 creates the orthopedic insert based on the design provided by the computer 10.

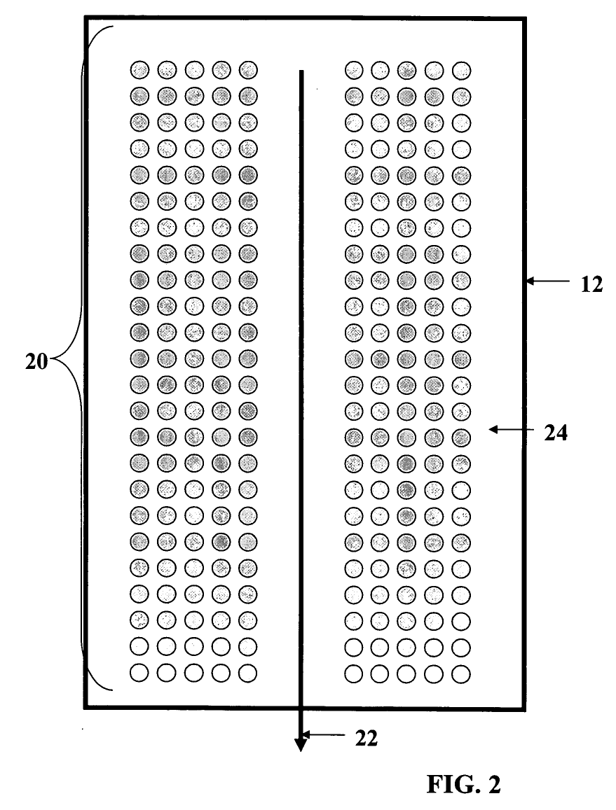

FIG. 2 illustrates a dynamic foot pressure measuring device 12 in accordance with one aspect of the present invention. The device 12 includes a platform that is long enough to allow a person to step along device 12, but the device 12 can also be longer to allow multiple strides by a person. The device includes a first plurality of pressure sensors 20. The sensors 20 are wide enough to receive the entirety of a person's foot. A second set of sensors 24 can also be provided so that both feet can be monitored.

The sensors can be piezoelectric devices. The piezoelectric devices sense pressure as a person steps on the device. The sensor can also be pressure pins that sink when a person steps on them. Foot measuring devices that use pressure pins are known.

Each of the sensors senses and records the pressure exerted on it by a foot over time. Thus, the pressure measurement of the foot is dynamic. The pressure sensed can be stored in a memory dedicated to each sensor. Alternatively, the memory can be dedicated to a bank of sensors or the pressure data can be transmitted off the device 12 through the communications link 22 on a real time basis. The communications link is connected, to each of the plurality of sensors. The communications link 22 can be a wireless communication link. Alternatively, it can be a hardwired link that is connected directly to a computer or processor.

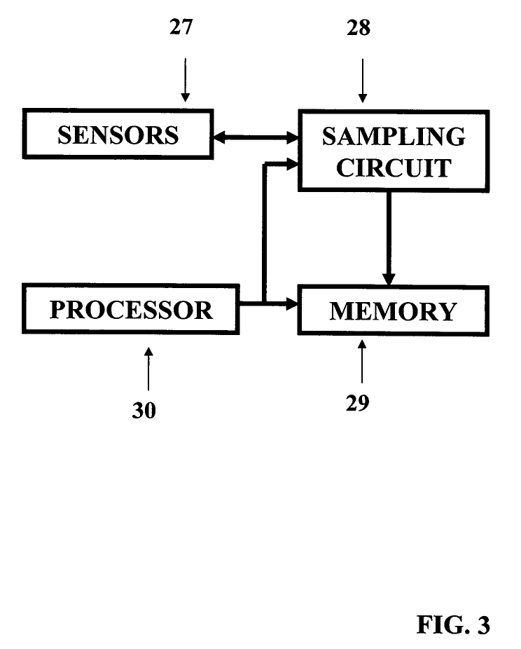

FIG. 3 illustrates a circuit on the device 12. The circuit includes the sensors 27, a sampling circuit 28, memory 29 and, optionally, a processor 30. The sampling circuit 28 controls the frequency of sampling the pressure obtained from each sensor in the sensor banks 27. A sampling frequency in the range of 100 ms to 250 ms is believed to be preferred, however, other sampling frequencies can be used. The sampling frequency can be faster or slower. Thus, each sensor in the bank of sensors 27 will provide a plurality of pressure readings that occur during a person's stride. These readings are stored in the memory 29. The readings stored in the memory 29 can be transmitted to the processor or computer 10 for further analysis. A processor 30 is optionally provided to control the sampling rate used by the sampling circuit 28. Thus, a controller could, depending on the circumstances and results obtained, change the sampling rate.

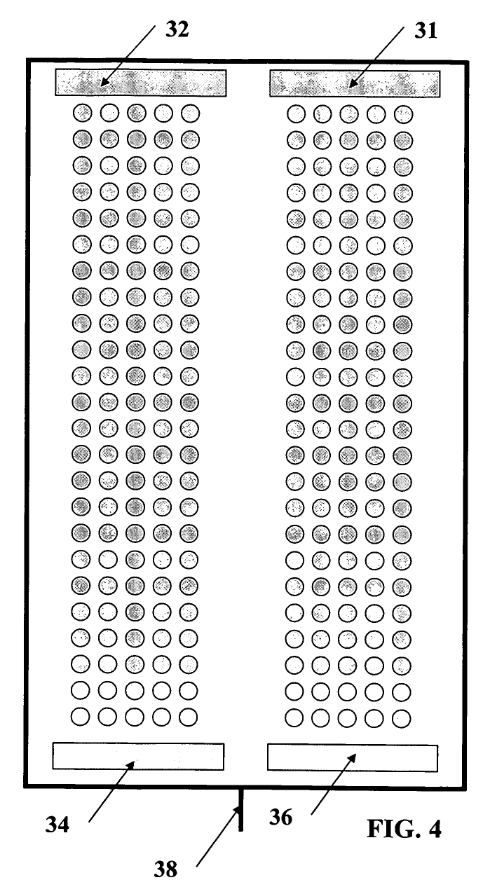

FIG. 4 illustrates another embodiment of the foot measurement device. This device includes the double bank of pressure sensors to measure the pressure exerted by a foot during a person's stride. The device also include four optical devices 31, 32, 34 and 36. These devices monitor the feet during the stride. The devices 31, 32, 34 and 36 can be video cameras, lasers or any other device that creates an image of the feet. These devices 31, 32, 34, and 36 monitor for sideways movement of a foot during a stride. The outputs from the video devices 31, 32, 34 and 36 are connected to the output terminal 38 and fed to a processor. The processor, in accordance with one aspect of the present invention, uses this information to determine any unwanted lateral motion of the foot during a stride.

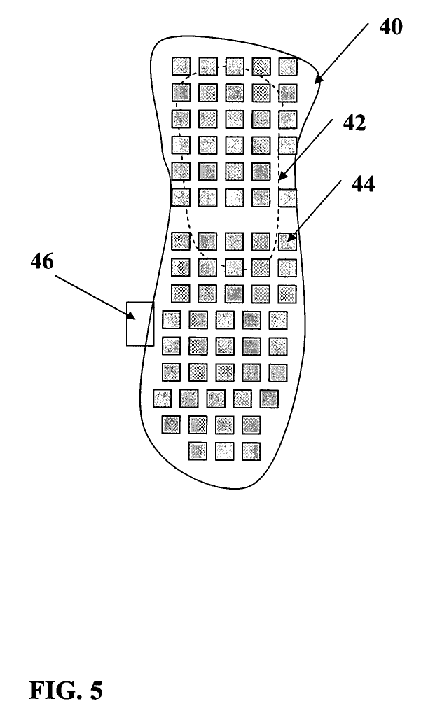

FIG. 5 illustrates device for measuring a foot in accordance with another aspect of the present invention. The device 40 is a sock-like device adapted to be pulled over the foot. It can be made of a knitted material that has some stretch to fit over a foot. FIG. 4 illustrates the bottom of the sock 40. The top surface of the sock 40 includes an opening 42 through which the foot fits.

A plurality of sensors 44 are located on a bottom surface of the sock 40. The plurality of sensors 44 are adapted to sense pressure exerted by the foot. The sensors 44 are preferably a piezoelectric devices. A circuit similar to the one illustrated in FIG. 3 is also provided on the sock 40 to control the acquisition of pressure data by the sensors 44.

A communications device 46 is provided on the sock and connected to the plurality of sensors or to a memory containing the data obtained from the sensors 44. The communications device 46 can either be a wireless transmitter or a hard wired communications link. The communications device 46 provides data from the sensors 44 to the processor 10.

Once the data has been provided to the processor 10, the data can be analyzed. It can be analyzed to provide visual depictions of the pressures exerted by a foot at a particular spot or at a number of spots. In accordance with one aspect of the present invention, pressure data obtained from a point over time is analyzed. Additionally, that analysis over time for a plurality of points is also provided.

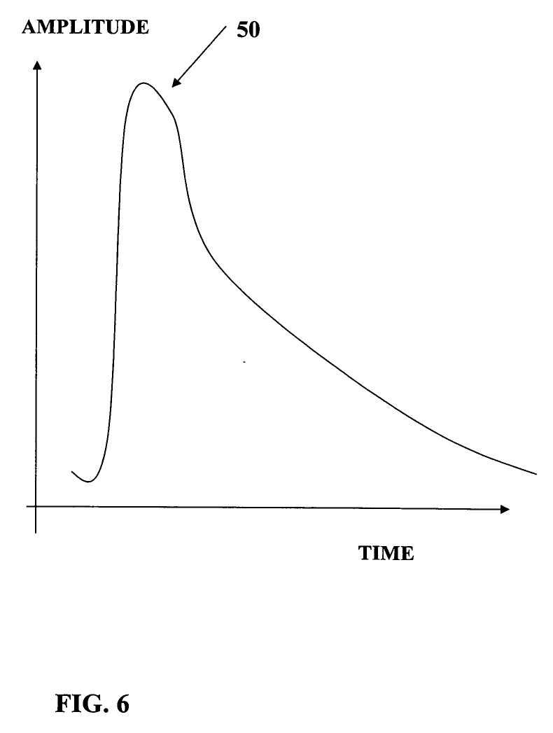

FIG. 6 illustrates a graph of the pressure sensed at one of the sensors over time is illustrated. The point is closer to the heel of the foot. As the heel is planted, the pressure sensed increases at time 50. As the stride continues, the heel lifts up, and the pressure decreases. Graphs of this nature are determined by the processor 10 and available for viewing from the processor 10.

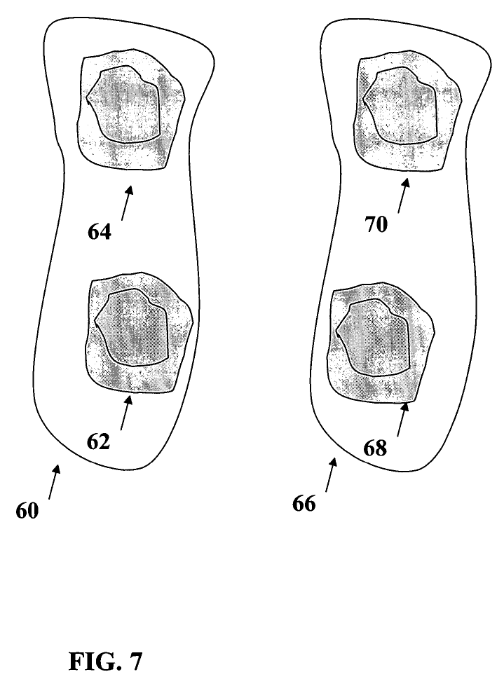

FIG. 7 illustrates computer images of pressure gradients generated at a first time and at a second time using a dynamic orthopedic insert measuring device. Gradient lines at a first time are illustrated in a first figure 60 at a position 64 near the heel and at a position near the toe 62. Gradient lines at a second time 66 are illustrated in a second figure 66 at a position 70 near the heel and at a position near the toe 68.

The graph of FIG. 6 can preferably be obtained in accordance with one aspect of the present invention by clicking on a spot of the gradient display.

In FIG. 7, the inner area at 64 is darker, indicating that there is more pressure being sensed at that point. The outer area at 64 is lighter indicating that there is less pressure being sensed. This is also true at points 62, 68 and 70.

By comparing successive images from successive times, problems with unwanted lateral movement of a foot can be detected. Referring to FIG. 7, for example, in image 60 at a first time, the toe oriented gradients 62 are located closer to the right side of the figure. In image 66, at a second time later than the first time, the pressure gradient has shifted toward the left side of the figure. This is indicative of a rolling problem that can be corrected with an orthopedic insert. The processor 10 detected these problems by comparing the pressure at a first of the plurality of points at a first time to the pressure at the first of the plurality of points at a second time. Each of the points in the array can be compared in this way.

The processor 10 also compares the pressure at a first of the plurality of points at a first time to the pressure at one or more or plurality of points that are neighbors to the first of the plurality of points at a second time. This way the processor 10 detects shifting or side to side pressures that occur during a stride. The processor 10, based on the analysis, designs an orthopedic insert to correct the problem and the milling machine 14 creates the orthopedic insert.

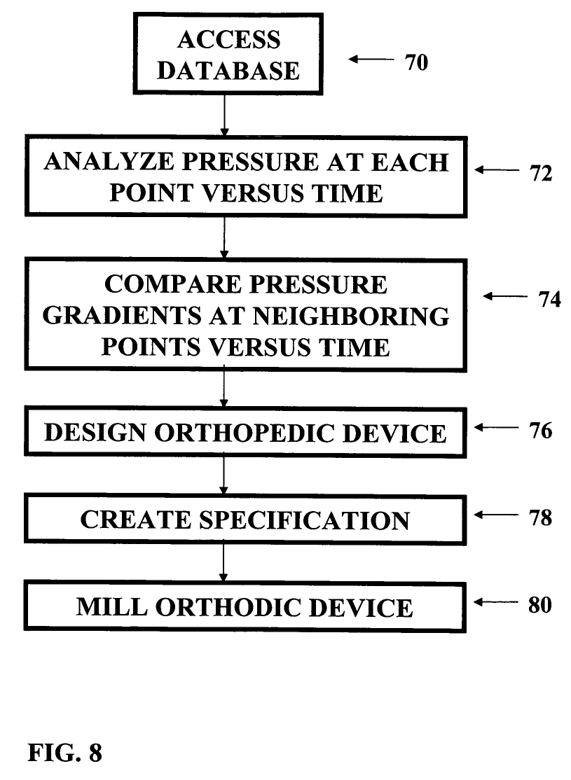

FIG. 8 illustrates a method in accordance with one aspect of the present invention. In step 70, the processor 10 accesses a database. The database stores the pressures sensed at each point in a sensor array at a plurality of times in accordance with the sampling rate. In step 72, the processor analyzes the pressure at each point in time to detect unwanted pressure gradients at any point on the foot. In step 74, the processor analyzes the pressure at neighboring points over time to detect any unwanted shifts of pressure that may occur during a stride. In step 76, based on the analysis, the processor 10 creates an orthopedic insert design. In step 78, a specification is created. In step 80, the milling machine 14 mills the orthopedic insert.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A method of measuring a foot and developing an orthopedic insert, comprising:
measuring a pressure the foot exerts during a stride at a plurality of points over a period of time;
analyzing a pressure at the plurality of points over the period of time; and
designing the orthopedic insert based on the analysis.

2. The method of claim 1, further comprising milling the orthopedic insert.

3. The method of claim 1, wherein the step of analyzing the pressure includes comparing the pressure at a first of the plurality of points at a first time to the pressure at the first of the plurality of points at a second time.

4. The method of claim 1, wherein the step of analyzing the pressure includes comparing the pressure at a first of the plurality of points at a first time to the pressure at one or more or plurality of points that are neighbors to the first of the plurality of points.

5. The method of claim 3, wherein the step of analyzing the pressure includes comparing the pressure at a first of the plurality of points at a first time to the pressure at one or more or plurality of points that are neighbors to the first of the plurality of points.

6. A device for measuring a foot, comprising:
a sock adapted to be pulled over the foot;
a plurality of sensors on a bottom surface of the sock, the plurality of sensors adapted to sense pressure exerted by the foot; and
a communications device on the sock and connected to the plurality of sensors.

7. The device of claim 6, wherein the communications device is a wireless transmitter.

8. The device of claim 6, wherein the communications device includes a memory that stores an output of the plurality of sensors.

9. The device of claim 8, wherein the communications device is a wireless transmitter.

10. The device of claim 8, wherein the communications device includes a wired output that can be connected to an external device to download information from the plurality of sensors.

11. A device for measuring a foot on a person, comprising:
a platform long enough to cover at least one stride of the person;
a first plurality of pressure sensors along a length of the platform, the first plurality of pressure sensors being wide enough to entirely receive the foot, so that each of the first plurality of pressure sensors can determine a pressure being exerted by the foot at one or more times; and
an output device connected to the first plurality of sensors.

12. The device of claim 11, further comprising a memory that receives and stores a plurality of pressure measurements from each of the plurality of sensors.

13. The device of claim 11, further comprising a second plurality of pressure sensors along a length of the platform, the second plurality of pressure sensors being wide enough to entirely receive the foot, so that each of the second plurality of pressure sensors can determine a pressure being exerted by the foot at one or more times.

14. The device of claim 11, wherein the first plurality of sensors are piezoelectric devices.

15. The device of claim 11, wherein the first plurality of sensors are pressure pins.

16. The device of claim 11, wherein the platform is long enough to cover a plurality of strides of the person.

17. The device of claim 11, further comprising imaging means for monitoring the foot during the stride.

18. A system, comprising:
a device that measures a pressure exerted by a foot at a plurality of times at each of a plurality of points;
a computer connected to the device, the computer having memory that stores the measured pressures and a program operable to analyze the measured pressures to create a design of an orthopedic insert.

19. The system of claim 18, further comprising a milling machine that can receive the design of the orthopedic insert and mill the orthopedic insert.

20. The system of claim 18, wherein the pressure at a first of the plurality of points at a first time is compared to the pressure at the first of the plurality of points at a second time.

21. The method of claim 18, wherein the pressure at a first of the plurality of points at a first time is compared to the pressure at one or more or plurality of points that are neighbors to the first of the plurality of points.

22. The method of claim 20, wherein the pressure at a first of the plurality of points at a first time is compared to the pressure at one or more or plurality of points that are neighbors to the first of the plurality of points.
